(19) United States
(12) Patent Application Publication
(10) Pub. No.: US 2024/0262308 A1
(43) Pub. Date: Aug. 8, 2024

(54) KNEE PROTECTOR FOR MOUNTING ON SEAT BACK IN FRONT OF USER

(71) Applicant: Azurous, Inc. dba Cabeau, Woodland Hills, CA (US)

(72) Inventor: David Sternlight, Woodland Hills, CA (US)

(21) Appl. No.: 18/434,571

(22) Filed: Feb. 6, 2024

Related U.S. Application Data
(60) Provisional application No. 63/483,500, filed on Feb. 6, 2023.

(51) Int. Cl. B60R 21/04; B60R 21/00

(52) U.S. Cl. CPC B60R 21/04; B60R 2021/0051; B60R 2021/0093

(57) ABSTRACT

A knee protection apparatus for travel having a padding body. The padding body having a body length extending between two ends, a body width, a body thickness, a front surface, a bottom surface, and a rear surface. The padding body provides a cushion for when a user's knees press against the front surface of the padding body. The padding body attaches with at least one mounting mechanism mounted on the back surface of the padding body and configured to mount to a seat in front of the user during travel. A container is attached to the bottom surface of the padding body and configured to hold travel items.

### CLAIM OF PRIORITY AND INCORPORATION BY REFERENCE

This application claims priority of U.S. Provisional Patent Application 63/483,500, titled “Knee Protector for Mounting on Seat Back in Front of User,” filed Feb. 6, 2023, the contents of which are incorporated herein by reference in its entirety.

### BACKGROUND

Passengers of an airplane or an automobile or any type of vehicle in which the passenger travels with a seat in front of the passenger may be subject to having their knees struck by the seat back of the seat in front of them. Taller passengers, such as those 6 feet or more, for example, almost certainly will have to suffer through a lack of leg room in most airplanes being flown by commercial airlines. This lack of legroom is growing due to the pressure to fill flights with as many passengers as possible. In the meantime, taller passengers will continue to risk having to either have their knees rub against the seat back of the seat in front of them, or have the seat back slam their knees when the person in the seat in front decides to recline his or her seat back towards to passenger.

It is noted that the problem with lack of legroom is not limited to commercial aircraft. Many automobiles have little room for passengers in the back seat, particularly for sports cars, compact, sub-compact, or otherwise very small cars.

In another aspect, passengers that use commercial aircraft have long been accustomed to using the pocket on the seat back of most commercial aircraft to hold the passengers' belongings, such as for example, mobile phones, wallets, books, water bottles, etc. Seat back pockets are however rarely cleaned, or at least rarely cleaned adequately. Over time, many people have stopped using the seat back pockets due to their filth even though passengers still have a need for a place to temporarily store their personal belongings during the flight.

There is a need for a way of increasing passenger comfort in seats that provide limited legroom as well as options for holding a passenger's belongings without having to store them in difficult to reach baggage.

### SUMMARY

In view of the above, a knee protection apparatus is provided for travel by a user. In an example implementation, the knee protection apparatus includes a padding body having a body length extending between two ends, a body width, a body thickness, a front surface, a bottom surface, and a rear surface. The padding body is configured to provide a cushioning when a user's knees press against the front surface of the padding body. At least one mounting mechanism is mounted on the back surface of the padding body and configured to mount to a seat in front of the user during travel. A container is attached to the padding body and configured to hold travel items.

In another aspect, the knee protection apparatus includes a pair of hooking mechanisms attached to opposite ends of the padding body.

In another aspect, the hooking mechanisms are carabiners.

In another aspect, the padding body is made of a conformable material.

In another aspect, the conformable material is memory foam.

In another aspect, the padding body comprises an inflatable body that is compressible when inflated.

In another aspect, the container is formed of a soft compressible material configured to provide an enclosure with an opening to the container.

In another aspect, the flat material is one of a cloth, nylon, polyester, or combinations thereof.

In another aspect, the container is configured to attach to the padding body at the opening of the enclosure.

In another aspect, the container is configured to attach directly to the padding body at the opening of the enclosure.

In another aspect, the container is attached to the padding body via a strap connected to the padding body and the container at opposite ends of the strap.

In another aspect, the container is a sack having a cord extending through a cord channel formed along the opening of the container, the cord having cord ends extending from cord channel openings spaced apart at the edge of the container to permit the user to cinch the opening of the container.

In another aspect, the cord includes a first cord lock configured to travel along a length of cord extending from one of the cord channel openings and a second cord lock configured to travel along the length of cord extending from the other cord channel opening.

In another aspect, the first cord lock is a male cord lock having a pin extending from an end of the male cord lock, and the second cord lock is a female cord lock having a lock opening into an end of the female cord lock, the pin in the male cord lock being configured to snap fit into the lock opening of the female cord lock.

In another aspect, the knee protection apparatus further comprises a body cord extending from the padding body, and a body cord lock configured to travel along the body cord.

In another aspect, the body cord lock includes a lock opening on one end of the body cord lock configured to receive the pin in the male cord lock on the cord of the container, where the attachment of the body cord lock to the male cord lock on the cord of the container is configured to maintain the container in a vertical upright position.

In another aspect, the body cord lock includes a pin on one end of the body cord lock configured to receive the pin in the male cord lock on the cord of the container, where the attachment of the body cord lock to the male cord lock on the cord of the container is configured to maintain the container in a vertical upright position.

In another aspect, the cord includes a grip and lock stop on each end of the container cord.

In another aspect, the cord includes a grip and lock stop on the end of the body cord.

In another aspect, the at least one attachment mechanism is a clip configured to clip on an edge of a seat pocket on a back of a seat in front of the user.

In another aspect, the at least one attachment mechanism is a magnet configured to attach to metal on a back of a seat in front of the user.

In another aspect, the padding body includes a cover made of either fabric, nylon, plastic, polyester, or a combination thereof.

### BRIEF DESCRIPTION OF THE FIGURES

FIG. 1A is a front view of an example knee protection apparatus.

FIG. 1B is a back view of the example knee protection apparatus shown in FIG. 1A.

FIG. 2A is a front view of another example knee protection apparatus.

FIG. 2B is a back view of the example knee protection apparatus of FIG. 2A.

FIG. 2C is a rear, side isometric view of the example knee protection apparatus of FIG. 2A.

FIG. 2D is a magnified of section A in FIG. 2B.

FIG. 2E shows enclosure mechanisms used in an example implementation of a container in an example implementation of the knee protection apparatus.

### DETAILED DESCRIPTION

The following description with reference to the accompanying drawings is provided to assist in a comprehensive understanding of example implementations of a knee protection apparatus. It is to be understood that the implementations described below are examples and that this disclosure is not intended to limit the invention to any example described below.

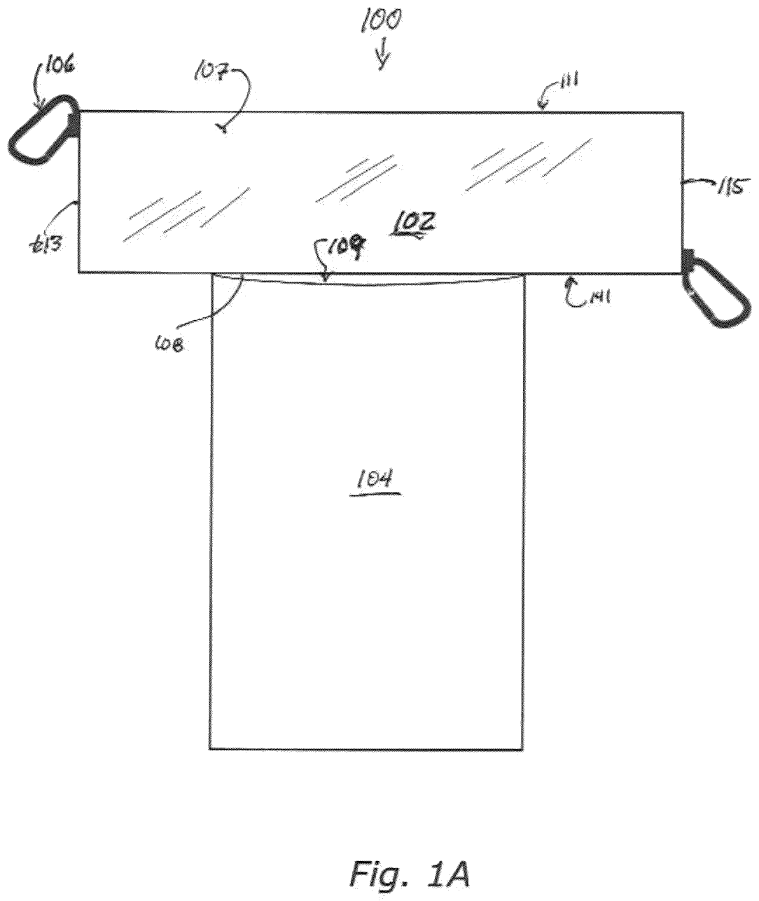

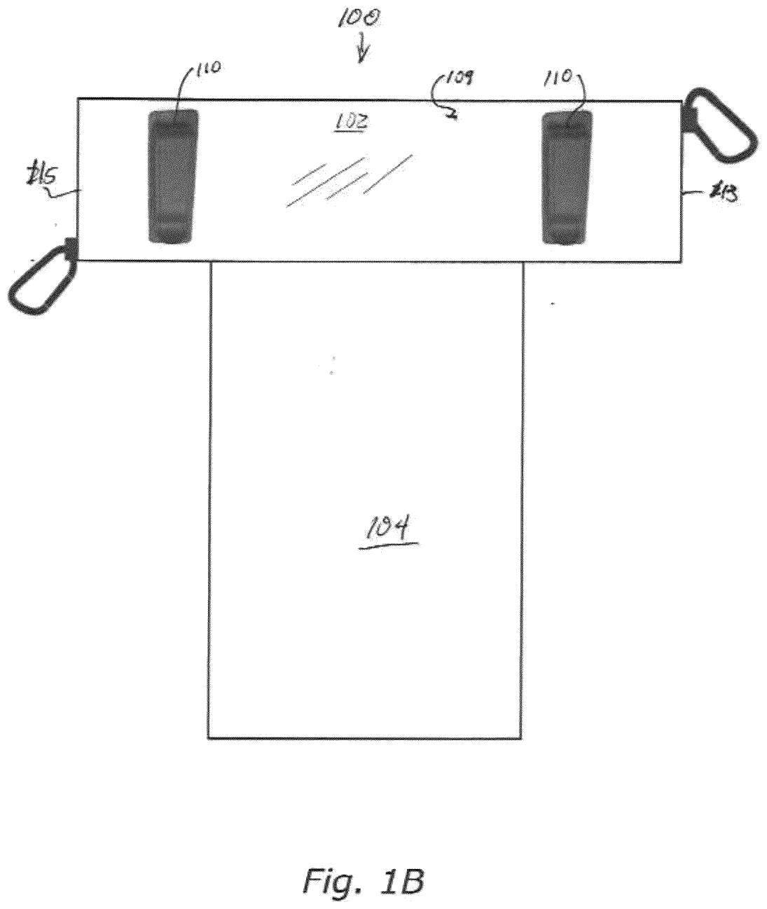

FIG. 1A is a front view of an example implementation of a knee protection apparatus 100. FIG. 1B is a back view of the example implementation in FIG. 1A. It is to be understood that the term “front” in relation to the view or to parts (e.g. surface) of the apparatus shall refer to such views or parts that face the user when the knee protection apparatus is in use. The term “back” in relation to the view or parts of the apparatus shall refer to such views that are opposite the parts that face the user when the knee protection apparatus is in use. The knee protection apparatus 100 may be used when traveling or sitting in a seat of a vehicle with limited leg room due to the proximity of the seat in front of the user. Such a situation is commonly encountered in seats on airplanes for commercial passenger flights where airlines tend to leave limited leg room for passengers in order to maximize the number of passengers on each plane. The knee protection apparatus 100 may be used in any similar situation on any type of vehicle, such as for example, trains, buses, cars, or any passenger vehicle that may have seats oriented one in front of the other.

The example knee protection apparatus 100 in FIG. 1A, which may also be referred to as a knee pad or knee protector, may be attached to the back of the seat in front of them. The knee protection apparatus 100 includes a padding body 102 to provide a cushion for the user's knee. The user may position the padding body 102 so as to protect the passenger's knees from either random knocks during the flight, or from the motion of the seat back when a second passenger in the seat in front of the first passenger reclines his seat towards the first passenger. A container 104, or pocket, or sack, may be attached to the padding body 102 and allowed to dangle from the knee pad when the knee pad is attached to the seat back of the seat in front of the passenger.

FIGS. 1A and 1B depict an example implementation of the knee protection apparatus 100 comprising a padding body 102, an attached pocket, or container 104, and a pair of hooking mechanisms 106 connected to diagonally opposite corners of the padding body 102. A pair of attachment mechanisms 110 are attached to the back of the padding body 102 to allow for mounting the padding body 102 on to the back of the seat in front of the passenger. In an example implementation, the attachment mechanisms 110 include clips configured to hook to a lip of a pocket on the seat back of the seat in front of the passenger. Such pockets are commonly found on passenger airplanes.

The padding body 102 may be made of a section of memory foam with a cover. The cover may be a fabric, plastic, nylon, leather, or any other suitable material. The example described with reference to FIGS. 1A and 1B uses memory foam formed in a rectangular section having a length of about 30 cm, a width of about 8 cm, and a depth of about 5 cm. It is noted that these dimensions are provided as example dimensions for the implementation illustrated below. The knee pad memory foam may be made to any suitable dimensions.

The padding body 102 and its dimensions are configured to allow a user to easily roll up the foam to make the knee pad more compact for packing or transporting. The hooking mechanisms 106, which are carabiners 106 in illustrated examples, are preferably mounted in a position that allows the user to clip one carabiner to the other to keep the foam rolled up and compressed while it is being transported. The carabiners 106 may also be used to clip the rolled-up knee pad to a hook on a backpack, a strap, a belt loop, or purse for transport. The carabiners 106 may also be used to hold a water bottle, a purse, or any other type of travel accessory that can be hooked to the carabiners 106, either while the knee pad is mounted to the seat in front, or when the knee pad is rolled up for transport.

The container 104 may be made of a suitable material such as fabric, nylon, plastic, etc. The material may be a fabric integrated with a fabric cover that covers the padding body 102. The material of the container 104 may also be separate and attached to the memory foam pad by sowing to a fabric cover over the padding body 102 or glued directly to a surface of the padding body 102 (whether covered or not) or attached by any other suitable attachment mechanism. The container 104 may be attached to the padding body 102 at a bottom surface, or at any other suitable portion of the padding body 102. The container 104 may open at the top of the container 104 near the attachment to the padding body 102 to hold a cell phone, a water bottle or beverage container, passport, a pen, earbuds, earplugs, sleep mask, wallet, etc.

The container 104 may be configured to wrap around the padding body 102 when not in use and rolled up with the padding body 102. Alternatively, the pocket may receive and contain the padding body 102 for storage. The portions of the padding body 102 that extend laterally away from the pocket may be rolled up and inserted into the container 104.

In one example implementation, the container 104 may be about 10 cm. wide and extend about 15 cm. downward. These dimensions are provided as examples only. The pocket may have any suitable dimensions.

The back of the padding body 102 may be secured to the pocket or other structure on the seat back of the seat in front of the user with the attachment mechanisms 110 as shown in FIG. 1B. The attachment mechanisms 110 in FIG. 1B are clips 110 and may be any suitable mechanical clip that may be glued or sown into a small pocket of the pad, otherwise attached to the back of the pad by any suitable means. Magnetic clips may also be used if deemed sufficiently capable of holding the pad and pocket to the seat back.

It is noted that the padding body 102 is described as made of memory foam. The padding body 102 may be made of any suitable material having properties similar to that of memory foam. The padding body 102 may also be an inflatable member that provides a cushion when inflated. The padding body 102 may be covered with fabric, nylon, plastic, leather, or any other suitable material. The carabiners 106 may be mounted using sown-in loops or by any other suitable material. Other attachment or hooking mechanisms may be used instead of carabiners. The hooking mechanisms 106 are shown on diagonally opposite corners of the padding body 102. However, the hooking mechanisms 106 may be secured to any suitable part of the padding body 102.

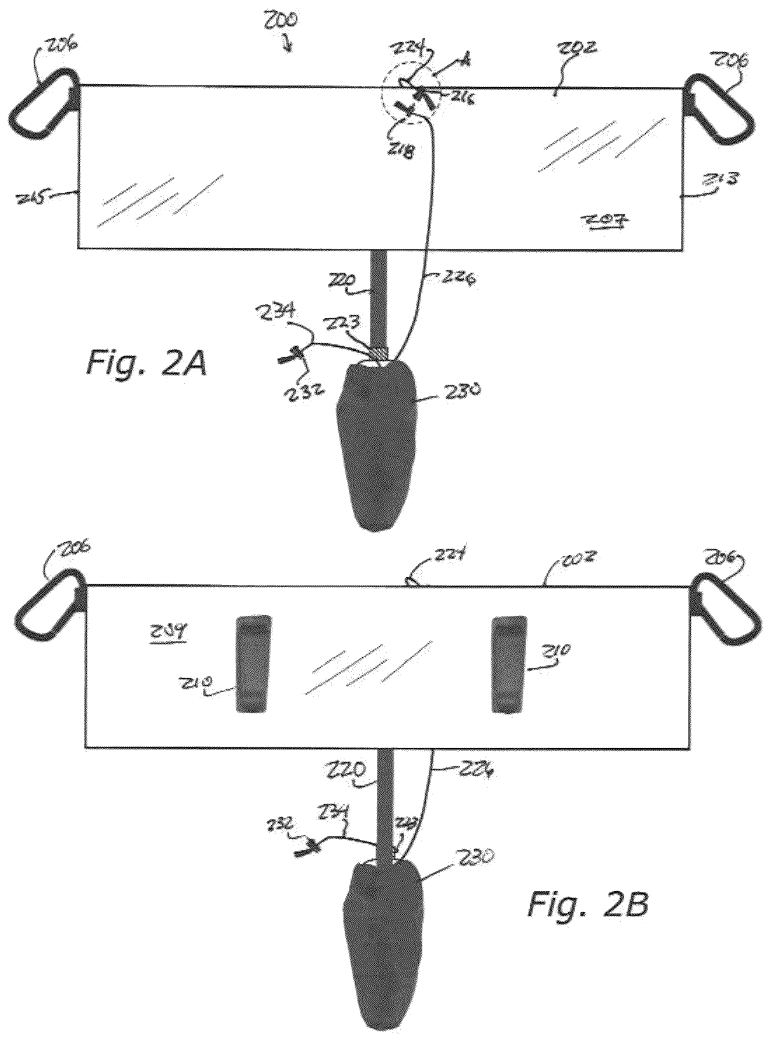

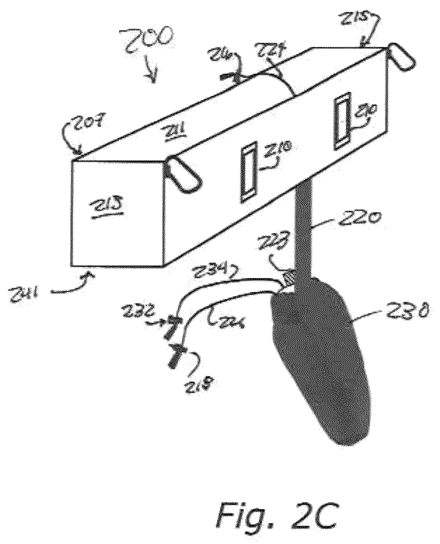

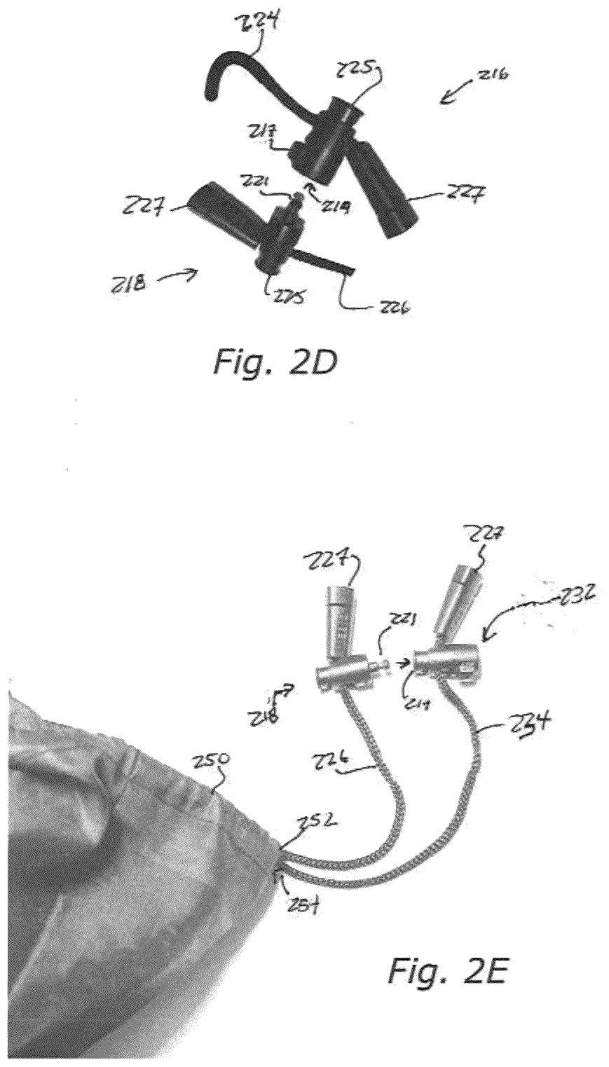

FIGS. 2A and 2B depict another example implementation of a knee protection apparatus 200 comprising a padding body 202, a container 220, and a pair of hooking mechanisms 206 connected to opposite corners of the padding body 102. FIG. 2C is a rear, side isometric view of the example knee protection apparatus of FIG. 2A.

Referring to FIGS. 2A-2C, a pair of attachment mechanisms 210 are attached to the back of the padding body 202 to allow for mounting the padding body 202 on to the back of the seat in front of the passenger. In an example implementation, the attachment mechanisms 210 include clips configured to hook to a lip of a pocket on the seat back of the seat in front of the passenger. Such pockets are commonly found on passenger airplanes.

The padding body 202 may be formed as a rectangular section having a front surface 207, a back surface 209, a top surface 211 and a bottom surface 241. The padding body 202 may be made of a section of memory foam with a cover. The cover may be a fabric, plastic, nylon, leather, or any other suitable material. The example described with reference to FIGS. 2A and 2B uses memory foam formed in a rectangular section similar to the padding body 102 in FIGS. 1A and 1B.

The padding body 202 may include a body cord 224 extending from any surface of the padding body 202. In the example shown in FIGS. 2A-2C, the body cord 224 extends from the top surface 211. The body cord 224 includes a body cord lock 216 configured to slide along the body cord and lock, preferably using spring lock.

The container 230 in FIGS. 2A-2C is suspended from the padding body 202 by the strap 220. The strap 220 may be attached to a bottom surface 241 and to a top of the container 230. The container 230 may be a draw string sack having a cord with cord ends 226, 234 extending from a channel or conduit on a top edge of the container 230, which holds the cord and allows the user to pull on the cord ends 226, 234 to close the container 230. The cord end 226 includes a first cord lock 218 and the cord ends 234 includes a second cord lock 232.

The container 230 may be made of a suitable material such as fabric, nylon, plastic, etc. The container 230 may be configured to hang from the padding body 202 to hold a cell phone, passport, a pen, earbuds, earplugs, sleep mask, wallet, etc.

As shown in FIGS. 2A and 2B, one of the cord ends 226 of the container enclosure cord may be pulled to connect to the body cord 224 on the padding body 202. The first cord lock 218 may be configured to mate with the body cord lock 216. The connection of the body cord 224 to the container cord at 226 allows the user to maintain the container in a vertical upright position by adjusting the tautness of the connection. Maintaining the container in a vertical upright position would keep a user's water bottle or beverage bottle upright as opposed to leaning to one side.

FIG. 2D shows a section A from FIG. 2A to more clearly illustrate the interaction between the cord lock 216 on the padding body 202 and the first cord lock 218 on the container cord 226. In the illustrated example, the first cord lock 218 includes an opening at 219 to allow a pin 221 extending from the first container cord lock 218 to snap fit locking the body cord lock 216 to the first container cord lock 218. The body cord lock 216, the first container cord lock 218, and the second container cord lock 232 may be spring cord locks movable by pressing on a button 225 on each cord lock, and locking by release of the button 225. The body cord 224 and the container cord 226, 234 may include grips on the respective cord ends to facilitate manipulation of the cords.

FIG. 2E shows enclosure mechanisms used in an example implementation of the container 230 in more detail. The container 230 includes a conduit 250 or channel 250 on an edge of the opening to the container 230 that holds the cord used to close the container 230. The conduit 250 includes a first opening 252 and a second opening from which the cord ends 226 extend. The first container cord lock 218 runs the length of one of the cord ends 226, and the second container cord lock 232 runs the length of the other cord end 234. The cord locks 218, 232 may be configured to lock to one another to allow the user to more fully close the container by moving the locked cord locks 218, 232 in towards the container opening, and tugging on both cord ends 226, 234. In the illustrated example, the first container cord lock 218 is a male cord lock having a pin 221 configured to snap fit into an opening 219 to the second container cord lock 232.

It is noted that the body cord lock 216 in the illustrated example is a female connector with the male first container cord lock 218. In other examples, the body cord lock 216 may be a male cord lock to mate with a female first container cord lock 218.

The padding body 202 and its dimensions are configured to allow a user to easily roll up the foam to make the knee pad more compact for packing or transporting. The hooking mechanisms 206, which are carabiners 206 in illustrated examples, are preferably mounted in a position that allows the user to clip one carabiner to the other to keep the foam rolled up and compressed while it is being transported. The carabiners 206 may also be used to clip the rolled-up knee pad to a hook on a backpack, a strap, a belt loop, or purse for transport. The carabiners 206 may also be used to hold a water bottle, a purse, or any other type of travel accessory that can be hooked to the carabiners 206, either while the knee pad is mounted to the seat in front, or when the knee pad is rolled up for transport.

The container 230 may be configured to wrap around the padding body 202 with the strap 220 when not in use and rolled up with the padding body 202. Alternatively, the container 230 may receive and contain the padding body 202 for storage.

The back of the padding body 202 may be secured to the pocket or other structure on the seat back of the seat in front of the user with the attachment mechanisms 210 as shown in FIG. 2B. The attachment mechanisms 210 in FIG. 2B are clips 210 and may be any suitable mechanical clip that may be glued or sown into a small pocket of the pad, otherwise attached to the back of the pad by any suitable means. Magnetic clips may also be used if deemed sufficiently capable of holding the pad and pocket to the seat back.

It is noted that the padding body 202 is described as made of memory foam. The padding body 202 may be made of any suitable material having properties similar to that of memory foam. The padding body 202 may also be an inflatable member that provides a cushion when inflated. The padding body 202 may be covered with fabric, nylon, plastic, leather, or any other suitable material. The carabiners 206 may be mounted using sown-in loops or by any other suitable material. Other attachment or hooking mechanisms may be used instead of carabiners.

The above describes an example implementation of a knee pad or knee protector that may be attached to a seat back of a seat in front of the user. It is noted that the example implementations described relate to uses primarily in aircraft. It is to be understood that examples of the knee pad described above may be used, or adapted for use in an automobile, a bus, a train, or in any other situation in which a user's knees may be subject to contact from an object in front of the user. The details of the implementation are described as examples and are not intended to limit any aspect of the knee pad in any way.

We claim:

1. A knee protection apparatus for travel comprising:
a padding body having a body length extending between two ends, a body width, a body thickness, a front surface, a bottom surface, and a rear surface, where the padding body is configured to provide a cushioning when a user's knees press against the front surface of the padding body;
at least one mounting mechanism mounted on the back surface of the padding body and configured to mount to a seat in front of the user during travel; and
a container attached to the bottom surface of the padding body and configured to hold travel items.

2. The knee protection apparatus of claim 1 further comprising a pair of hooking mechanisms attached to opposite ends of the padding body.

3. The knee protection apparatus of claim 2 where the hooking mechanisms are carabiners.

4. The knee protection apparatus of claim 2 where one hooking mechanism is affixed to a corner on the top surface of one end of the padding body and the other hooking mechanism is mounted on the bottom surface of the opposite end of the padding body.

5. The knee protection apparatus of claim 2 where one hooking mechanism is affixed to a corner on the top surface of the padding body and the other hooking mechanism is mounted on the bottom surface of the padding body.

6. The knee protection apparatus of claim 1 where the padding body is made of a conformable material.

7. The knee protection apparatus of claim 6 where the conformable material is memory foam.

8. The knee protection apparatus of claim 1 where the padding body comprises an inflatable body that is compressible when inflated.

9. The knee protection apparatus of claim 1 where the container is formed of a soft compressible material configured to provide an enclosure with an opening to the container.

10. The knee protection apparatus of claim 9 where the flat material is one of a cloth, nylon, polyester, or combinations thereof.

11. The knee protection apparatus of claim 9 where the container is configured to attach to the padding body at the opening of the enclosure.

12. The knee protection apparatus of claim 11 where the container is configured to attach directly to the padding body at the opening of the enclosure.

13. The knee protection apparatus of claim 11 where the container is attached to the padding body via a strap connected to the padding body and the container at opposite ends of the strap.

14. The knee protection apparatus of claim 11 where the container is configured to form a sack having a cord extending through a cord channel formed along the opening of the container, the cord having cord ends extending from cord channel openings spaced apart at the edge of the container to permit the user to cinch the opening of the container.

15. The knee protection apparatus of claim 14 where the cord includes a first cord lock configured to travel along a length of cord extending from one of the cord channel openings and a second cord lock configured to travel along the length of cord extending from the other cord channel opening.

16. The knee protection apparatus of claim 15 where the first cord lock is a male cord lock having a pin extending from an end of the male cord lock, and the second cord lock is a female cord lock having a lock opening into an end of the female cord lock, the pin in the male cord lock being configured to snap fit into the lock opening of the female cord lock.

17. The knee protection apparatus of claim 16 further comprising a body cord extending from the padding body, and a body cord lock configured to travel along the body cord.

18. The knee protection apparatus of claim 17 where the body cord lock includes a lock opening on one end of the body cord lock configured to receive the pin in the male cord lock on the cord of the container, where the attachment of the body cord lock to the male cord lock on the cord of the container is configured to maintain the container in a vertical upright position.

19. The knee protection apparatus of claim 17, where the body cord lock includes a pin on one end of the body cord lock configured to receive the pin in the male cord lock on the cord of the container, where the attachment of the body cord lock to the male cord lock on the cord of the container is configured to maintain the container in a vertical upright position.

20. The knee protection apparatus of claim 14 where the cord includes a grip and lock stop on each end of the container cord.

21. The knee protection apparatus of claim 17 where the cord includes a grip and lock stop on the end of the body cord.

22. The knee protection apparatus of claim 1 where the at least one attachment mechanism is a clip configured to clip on an edge of a seat pocket on a back of a seat in front of the user.

23. The knee protection apparatus of claim 1 where the at least one attachment mechanism is a magnet configured to attach to metal on a back of a seat in front of the user.

24. The knee protection apparatus of claim 1 where the padding body includes a cover made of either fabric, nylon, plastic, polyester or a combination thereof.
